(19) United States
(12) Patent Application Publication
(10) Pub. No.: US 2026/0171583 A1
(43) Pub. Date: Jun. 18, 2026

(54) BATTERY MODULE AND METHOD OF MANUFACTURING BATTERY MODULE

(71) Applicant: Samsung SDI Co., Ltd., Yongin-si (KR)

(72) Inventors: Cheorlhwan Kim, Yongin-si (KR); Jangyeong Im, Yongin-si (KR); Jongtaek Park, Yongin-si (KR); Sangik Lee, Yongin-si (KR)

(73) Assignee: Samsung SDI Co., Ltd., Yongin-si (KR)

(21) Appl. No.: 19/419,583

(22) Filed: Dec. 15, 2025

(30) Foreign Application Priority Data
Dec. 17, 2024 (KR) 10-2024-0189305

(51) Int. Cl. H01M 50/269; H01M 10/48; H01M 10/653; H01M 50/293

(52) U.S. Cl. CPC H01M 50/269; H01M 10/482; H01M 10/653; H01M 50/293

(57) ABSTRACT

Disclosed herein are a battery module and a method of manufacturing the battery module. The battery module includes: a cell stack including a plurality of battery cells; an outer partition forming an external housing; an inner partition fixed to the outer partition and supporting a side surface of the cell stack; a movable end block supporting an outermost battery cell of the cell stack, and configured to move along the inner partition and apply pressure to the cell stack; and a movable partition functioning as an intermediate partition positioned between the outer partition and the inner partition, the movable partition being configured to have a same height as the outer partition and define a first internal space between the outer partition and the movable partition. The movable partition moves along the outer partition and varies a size of the first internal space.

### CROSS-REFERENCE TO RELATED APPLICATIONS

This present application claims priority to and the benefit under 35 U.S.C. § 119(a)-(d) of Korean Patent Application No. 10-2024-0189305, filed on Dec. 17, 2024, in the Korean Intellectual Property Office, the entire disclosure of which is incorporated herein by reference.

### FIELD

The present disclosure relates to a battery module and a method of manufacturing the battery module, and more particularly, to a battery module capable of adjusting the size of an internal space defined in the battery module by moving a movable partition, and a method of manufacturing the battery module.

### BACKGROUND

Unlike primary batteries that are not designed to be charged, secondary batteries are designed to be discharged and recharged. Low-capacity secondary batteries are used in small portable electronic devices, such as smart phones, feature phones, notebook computers, digital cameras, and camcorders, while large-capacity secondary batteries are widely used as power sources for driving motors, such as of hybrid vehicles or electric vehicles, and for power storage. The secondary battery includes an electrode assembly consisting of a positive electrode and a negative electrode, a case that accommodates the electrode assembly, a terminal part connected to the electrode assembly, etc.

Taking into account convenience, production time, and cost, a module for evaluation with a smaller number of battery cells than an actual module may be used to perform a test for evaluating the thermal propagation delay performance of a secondary battery module.

Conventional modules for evaluation are completed by placing battery cells and end blocks for supporting the battery cells in manufacturing equipment to which a pressure sensor is attached, and fabricating a jig by fastening a side plate to the end blocks.

However, since a module needed for testing and evaluating thermal propagation delay performance varies in terms of the required size of a cell stack and the required size of an internal space formed in the module for each test evaluation, a conventional module manufacturing method has required numerous trial-and-error issues to manufacture a suitable module.

Furthermore, in the case where the number of test evaluation cells in the module or the size of the internal space formed in the module varies, the previously manufactured module may become unusable, resulting in the need to manufacture an additional module.

The above information disclosed in this Background section is for enhancement of understanding of the background of the present disclosure, and therefore, it may contain information that does not constitute related (or prior) art.

### SUMMARY

Embodiments of the present disclosure are directed to providing a battery module capable of adjusting the size of an internal space defined in the battery module by moving a movable partition, and a method of manufacturing the battery module.

However, the technical problem to be solved by the present disclosure is not limited to the problems described herein, and other problems not mentioned herein, and aspects and features of the present disclosure that would address such problems, will be clearly understood by those skilled in the art from the description of the present disclosure herein.

A battery module according to embodiments of the present disclosure may include: a cell stack including a plurality of battery cells; an outer partition forming an external housing; an inner partition fixed to the outer partition and supporting a side surface of the cell stack; a movable end block supporting an outermost battery cell of the cell stack, and configured to move along the inner partition and apply pressure to the cell stack; and a movable partition functioning as an intermediate partition positioned between the outer partition and the inner partition, the movable partition being configured to have a same height as the outer partition and define a first internal space between the outer partition and the movable partition. The movable partition may move along the outer partition and vary a size of the first internal space.

In embodiments, the battery module may further include a first movable component coupled to a surface of the outer partition, and configured to move the movable end block.

In embodiments, the battery module may further include a second movable component coupled to another surface of the outer partition, and configured to move the movable partition.

In embodiments, the battery module may further include a pressure sensor interposed between the movable end block and the first movable component.

In embodiments, the second movable component may be a screw having a thread formed on a surface thereof so that the screw moves the movable partition according to rotation thereof.

In embodiments, the battery module may further include an upper sheet positioned above a second internal space defined by the outer partition, the movable end block, and the inner partition, and configured to perform a dummy cell function.

In embodiments, the upper sheet may be formed of a mica sheet having a constant thickness.

A battery module according to embodiments of the present disclosure may include: a cell stack including a plurality of battery cells; an outer partition forming an external housing; an inner partition fixed to the outer partition and supporting a side surface of the cell stack; a movable end block supporting an outermost battery cell of the cell stack, and configured to move along the inner partition and apply pressure to the cell stack; a sand block positioned between the outer partition and the inner partition, and configured to perform a sandbox function; and a second movable component coupled to a surface of the outer partition, and configured to move the sand block in a direction.

In embodiments, the battery module may further include a third movable component coupled to another surface of the outer partition, and configured to move the sand block in another direction.

In embodiments, the second movable component and the third movable component may be configured to adjust a size of the sand block.

A method of manufacturing a battery module according to embodiments of the present disclosure may include: providing a cell stack including a plurality of battery cells; providing an outer partition forming an external housing; providing an inner partition that is fixed to the outer partition and supports a side surface of the cell stack; providing a movable end block that supports an outermost battery cell of the cell stack, moves along the inner partition, and applies pressure to the cell stack; providing a movable partition functioning as an intermediate partition positioned between the outer partition and the inner partition, the movable partition being configured to have a same height as the outer partition and define a first internal space between the outer partition and the movable partition; and moving the movable partition along the outer partition, and varying a size of the first internal space.

In embodiments, the method may further include coupling a first movable component to a surface of the outer partition, the first movable component being configured to move the movable end block.

In embodiments, the method may further include coupling a second movable component to another surface of the outer partition, the second movable component being configured to move the movable partition.

In embodiments, the method may further include interposing a pressure sensor between the movable end block and the first movable component.

In embodiments, the second movable component may include a screw having a thread formed on a surface thereof so that the screw moves the movable partition according to rotation thereof.

In embodiments, the method may further include providing an upper sheet above a second internal space defined by the outer partition, the movable end block, and the inner partition, the upper sheet performing a dummy cell function.

In embodiments, the upper sheet may be formed of a mica sheet having a constant thickness.

A method of manufacturing a battery module according to embodiments of the present disclosure may include: providing a cell stack including a plurality of battery cells; providing an outer partition forming an external housing; providing an inner partition that is fixed to the outer partition and supports a side surface of the cell stack; providing a movable end block that supports an outermost battery cell of the cell stack, moves along the inner partition, and applies pressure to the cell stack; providing a sand block positioned between the outer partition and the inner partition and configured to perform a sandbox function; and coupling a second movable component to a surface of the outer partition, the second movable component being configured to move the sand block in a direction.

In embodiments, the method may further include coupling a third movable component to another surface of the outer partition, the third movable component being configured to move the sand block in another direction.

In embodiments, the method may further include adjusting a size of the sand block by using the second movable component and the third movable component.

According to embodiments of the present disclosure, a cell stack space and an internal space of a battery module can be easily formed to the sizes required for test evaluation.

According to embodiments of the present disclosure, the movable structure of a movable block may provide flexibility for dimensional changes of the cell stack and enables test evaluation of various cell thicknesses and quantities, thereby removing the need to manufacture an additional battery module when an insulation sheet, cell type, or cell quantity is changed.

According to embodiments of the present disclosure, the movable structure of a movable partition allows the internal space of the module to be easily adjusted to the size required for test evaluation. Additionally, the flexibility in modifying the internal space allows for test evaluation under various conditions.

According to embodiments of the present disclosure, the sizes of the cell stack and the internal space of the battery module may be easily adjusted, preventing various trial-and-error issues that may occur during an initial stage of a process of manufacturing the battery module.

According to embodiments of the present disclosure, the battery module can be manufactured regardless of the dimensions of the cell stack and the internal space of the battery module, thus reducing the time and cost required for pre-manufacturing the battery module.

According to embodiments of the present disclosure, the battery module may be universally compatible, thereby enabling shared use of an existing battery module across different projects.

However, aspects and features of the present disclosure are not limited to those described herein, and other aspects and features not mentioned will be clearly understood by a person skilled in the art from the detailed description, described herein.

### BRIEF DESCRIPTION OF THE DRAWINGS

The following drawings attached to the present specification illustrate embodiments the present disclosure, and further describe aspects and features of the present disclosure together with the detailed description of the present disclosure. Thus, the present disclosure should not be construed as being limited to the drawings:

FIG. 1A is a top perspective view of a prismatic secondary battery.

FIG. 1B is a sectional view taken along line I-I′ of FIG. 1A.

FIG. 2 is a diagram illustrating a conventional battery module for evaluation.

FIG. 3A is a front view and FIG. 3B is a side view illustrating a battery module according to embodiments of the present disclosure.

FIG. 4A is a front view and FIG. 4B is a side view illustrating a battery module according to embodiments of the present disclosure.

FIG. 5 is a side view illustrating a battery module according to embodiments of the present disclosure.

FIG. 6 is a side view illustrating a battery module according to embodiments of the present disclosure.

FIG. 7A is a front view and FIG. 7B is a side view illustrating a battery module according to embodiments of the present disclosure.

FIG. 8 is a flowchart for describing a method of manufacturing a battery module according to embodiments of the present disclosure.

### DETAILED DESCRIPTION

Exemplary embodiments of the present disclosure will be described herein in detail with reference to the accompanying drawings. Prior to the description, it is noted that the terms or words used in this specification and claims should not be construed as being limited to common or dictionary meanings but instead should be understood to have meanings and concepts in agreement with the spirit of the present disclosure based on the principle that an inventor can define the concept of each term suitably in order to describe his/her own disclosure in the best way possible. Accordingly, since the embodiments described in this specification and the configurations illustrated in the drawings are only an example of the present disclosure and they do not cover all the technical ideas of the present disclosure, it should be understood that various changes and modifications may be made at the time of filing this application.

It will be further understood that the terms “comprises/includes” and/or “comprising/including” when used herein, specify the presence of stated features, integers, steps, operations, elements, components, and/or groups thereof, but do not preclude the presence or addition of one or more Other features, integers, steps, operations, elements, components, and/or groups thereof.

In order to facilitate understanding of the present disclosure, the accompanying drawings are not drawn to scale and the dimensions of some components may be exaggerated. It should be noted that the same reference numerals are designated to the same components in different embodiments.

Reference to two compared elements, features, etc. as being “the same” means that they are “substantially the same”. Therefore, the phrase “substantially the same” may include a deviation that is considered low in the art, for example, a deviation of 5% or less. The uniformity of any parameter in a given region may mean that it is uniform from an average perspective.

Although the terms such as “first” and/or “second” are used to describe various components, these components are not limited by these terms, of course. These terms are only used to distinguish one component from another component. Thus, unless specifically stated to the contrary, a first component may be termed a second component without departing from the teachings of exemplary embodiments.

Throughout the specification, unless otherwise stated, each element may be singular or plural.

Arrangement of any component “above (or below) ” or “on (or under) ” a component may mean that any component is disposed in contact with the upper (or lower) surface of the component, as well as that other components may be interposed between the element and any element disposed on (or under) the element.

It will be understood that, when a component is referred to as being “connected”, “coupled”, or “joined” to another component, not only can it be directly “connected”, “coupled”, or “joined” to the other element, but also can it be indirectly “connected”, “coupled”, or “joined” to the other element with other elements interposed therebetween.

As used herein, the term “and/or” includes any and all combinations of one or more of the associate listed items. The use of “may” when describing embodiments of the present disclosure relates to “one or more embodiments of the present disclosure”. Expressions such as “at least one” and “one or more” preceding a list of elements modify the entire list of elements and do not modify the individual elements in the list.

Throughout the specification, when “A and/or B” is stated, it means A, B, or A and B, unless otherwise stated. In addition, when “C to D” is stated, it means C or more and D or less, unless specifically stated to the contrary.

When the phrase such as “at least one of A, B, and C”, “at least one of A, B, or C”, “at least one selected from the group of A, B, and C”, or “at least one selected from among A, B, and C” is used to designate a list of elements A, B, and C, the phrase may refer to any and all suitable combinations.

The term “use” may be considered synonymous with the term “utilize”. As used herein, the terms “substantially,” “about,” and similar terms are used as terms of approximation rather than as terms of degree, and are intended to account for inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Accordingly, a first element, component, region, layer, or section discussed herein may be termed a second element, component, region, layer, or section without departing from the teachings of exemplary embodiments.

For ease of explanation in describing the relationship of one element or feature to another element(s) or feature(s) as illustrated in the drawings, spatially relative terms such as “beneath”, “below”, “lower”, “above”, and “upper” may be used herein. It will be understood that spatially relative positions are intended to encompass different directions of the device in use or operation in addition to the direction depicted in the drawings. For example, if the device in the drawings is turned over, any element described as being “below” or “beneath” another element would then be oriented “above” or “over” another element. Therefore, the term “below” may encompass both upward and downward directions.

The terminology used herein is for the purpose of describing embodiments of the present disclosure and is not intended to limit the present disclosure.

The present disclosure will be described in detail with reference to the attached drawings.

Examples of secondary batteries include a coin type, a cylindrical type, a prismatic type, and a pouch type. The present disclosure is basically applicable to a prismatic secondary battery. Therefore, the prismatic secondary battery will first be briefly described prior to description of embodiments of the present disclosure.

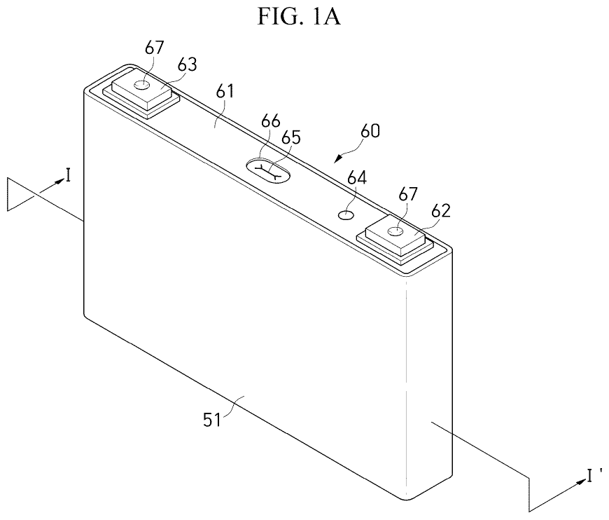

FIG. 1A is a top perspective view of the prismatic secondary battery. FIG. 1B is a cross-sectional view taken along line I-I′ of FIG. 1A.

First, the external appearance of the prismatic secondary battery illustrated in FIG. 1A will be described.

A casing 51 defines an overall appearance of the prismatic secondary battery, and may be made of conductive metal, such as aluminum, aluminum alloy, nickel-plated steel. In addition, the casing 51 may provide a space for accommodating an electrode assembly therein.

A cap assembly 60 may include a cap plate 61 that covers the opening of the casing 51, and the cap assembly 60 and the cap plate 61 may be made of a conductive material. Here, a first terminal 63 and a second terminal 62 may be electrically connected to respective positive and negative (or negative and positive) electrodes inside the casing, and may be installed to protrude outward through the cap plate 61.

The cap plate 61 may be equipped with an electrolyte injection port 64 formed to install a sealing plug, and a vent 66 formed with a notch 65. The vent 66 is for degassing the secondary battery, i.e., for discharging gas generated inside the secondary battery.

With reference to FIG. 1B, the internal structure of the prismatic secondary battery and the coupling structure with the cap assembly 60 will be described.

As illustrated in FIG. 1B, the prismatic secondary battery may basically include an electrode assembly 40, a first current collector part 41, a first terminal 62, a second current collector part 42, a second terminal 63, and a cap assembly 60.

The electrode assembly 40 may be formed by winding or stacking a laminate of a first electrode plate, a separator, and a second electrode plate, which are in the form of a plate or a film. When the electrode assembly 40 is a wound laminate, it may have a winding axis parallel to the longitudinal direction of the casing. The electrode assembly 40 may be of a stack type rather than a winding type, but the shape of the electrode assembly 40 is not limited in the present disclosure. In addition, the electrode assembly 40 may be a Z-stack electrode assembly in which a first electrode plate and a second electrode plate are inserted into both sides of a separator bent into a Z-stack. Furthermore, the electrode assembly 40 may consist of one or more electrode assemblies, which are stacked such that their long sides are adjacent to each other and accommodated in the casing, and the number of electrode assemblies is not limited in the present disclosure. The electrode assembly 40 may have a first electrode plate that acts as a negative electrode and a second electrode plate that acts as a positive electrode, or vice versa.

The first electrode plate may be formed by applying a first electrode active material, such as graphite or carbon, to a first electrode current collector plate made of metal foil, such as copper, copper alloy, nickel, or nickel alloy. The first electrode plate may include a first electrode tab (or first uncoated part) 43, which is a region without application of the first electrode active material. The first electrode tab 43 may act as a current flow passage between the first electrode plate and the first current collector part 41. In some examples, the first electrode tab 43 may be formed by cutting the first electrode plate to protrude to one side in advance when manufacturing the first electrode plate, and may protrude further to one side than the separator without separate cutting.

The second electrode plate may be formed by applying a second electrode active material such as transition metal oxide to a substrate made of metal foil, such as aluminum or aluminum alloy. The second electrode plate may include a second electrode tab (or second uncoated part) 44, which is a region without application of the second electrode active material. The second electrode tab 44 may act as a current flow passage between the second electrode plate and the second current collector part 42. In some examples, the second electrode tab 44 may be formed by cutting the second electrode plate to protrude to the other side in advance when manufacturing the second electrode plate, and may protrude further to the other side than the separator without separate cutting.

In some embodiments, the first electrode tab 43 may be located on the right end side of the electrode assembly 40, and the second electrode tab 44 may be located on the left end side of the electrode assembly 40. Alternatively, the first electrode tab 43 and the second electrode tab 44 may be located on one end side of the electrode assembly 40 in the same direction. Here, the left and the right are represented based on the secondary battery illustrated in FIG. 1 for convenience of explanation, and they may change in position when the secondary battery is rotated left and right or up and down.

The separator functions to prevent a short circuit between the first electrode plate and the second electrode plate while permitting migration of lithium ions therebetween. The separator may be made of, for example, a polyethylene film, a polypropylene film, a polyethylene-polypropylene film, or the like.

The first electrode tab 43 of the first electrode plate and the second electrode tab 44 of the second electrode plate extend from both ends of the electrode assembly as described herein, respectively. In some embodiments, the electrode assembly 40 may be accommodated together with an electrolyte in the casing 51.

In the electrode assembly 40, the first current collector part 41 and the second current collector part 42 may be welded and connected to the first electrode tab 43 extending from the first electrode plate and the second electrode tab 44 extending from the second electrode plate, respectively.

The first current collector part 41 and the second current collector part 42 are connected to the first terminal 62 and the second terminal 63, as described with reference to FIG. 1A, through terminal pins 67, respectively. In some embodiments, the terminal pins 67 may each have an outer peripheral surface that is threaded, and may be fastened to the first terminal 62 and the second terminal 63 by screwing. However, the present disclosure is not limited thereto. For example, the terminal pins 67 may also be coupled to the first terminal 62 and the second terminal 63 by riveting or welding.

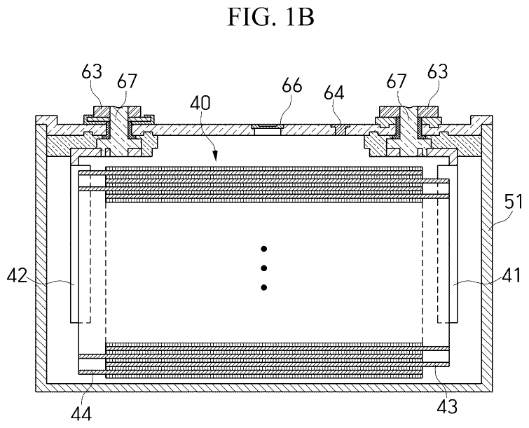

FIG. 2 is a diagram illustrating a conventional battery module for evaluation.

Referring to FIG. 2, the conventional battery module for evaluation may be completed by placing battery cells 1 and end blocks 2 and 3 for supporting the battery cells 1 in manufacturing equipment to which a pressure sensor is attached, and fabricating a jig by fastening a side plate 4 to the end blocks 2 and 3.

Various types of insulation sheets may be applied to the battery module, and the battery module may be evaluated, and the performance thereof may be compared. A distance between fastening holes formed in the side plate 4 for fastening the end blocks 2 and 3 is fixed, and the end blocks 2 and 3 are secured by tightening bolts 5 into the fastening holes. Here, there may be differences in thickness between the insulation sheets. Hence, in the case where various types of insulation sheets are applied for evaluation, a difference in the pressure of the fabricated battery module may occur.

To eliminate the aforementioned difference, a conventional method of manufacturing a battery module for evaluation may include inserting spacers between the battery cells 1 and the end blocks 2 and 3.

Therefore, in the conventional manufacturing of the battery module for evaluation, trial and error may be required to fabricate a jig that meets a desired pressure. Alternatively, the battery module may be manufactured by allowing extra space in dimensions of the side plate 4 and filling a remaining space with an insulation sheet or plate. Furthermore, in the case where the number of evaluation cells in the battery module changes or the insulation sheet is replaced, the previously manufactured battery module may become unusable, resulting in the need to manufacture an additional module.

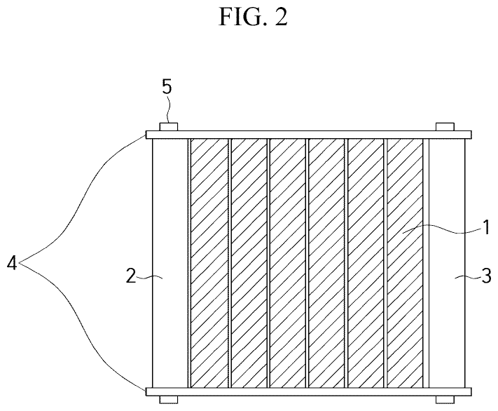

FIG. 3 is a front view (a) and a side view (b) illustrating a battery module 10 according to embodiments of the present disclosure.

Referring to FIGS. 3A and 3B, the battery module 10 according to the first embodiment of the present disclosure may include a cell stack 100, a movable end block 110, an outer partition 120, a first movable component 130, an inner partition 140, a second movable component 150, a movable partition 160, a bottom portion 170, a cover portion 180, and a pressure sensor 190.

The cell stack 100 may include a plurality of battery cells, and may include an insulation sheet for evaluating thermal propagation delay performance. The cell stack 100 may further include a heater for a thermal propagation trigger or auxiliary materials such as other blocks.

The movable end block 110 may be configured to support one of outermost battery cells of the cell stack 100. The movable end block 110 may include a first movable end block and a second movable end block. The first movable end block may support one of the outermost battery cells of the cell stack 100, and the second movable end block may support a remaining one of the outermost battery cells of the cell stack 100.

The movable end block 110 may be coupled to the first movable component 130, which will be described herein, and may be configured to be movable along the inner partition 140 rather than being secured to the inner partition 140, which will be described herein.

The movable end block 110 may be moved along the inner partition 140 by the first movable component 130. As the movable end block 110 moves along the inner partition 140, the movable end block 110 may apply pressure to the cell stack 100.

The outer partition 120 may serve as an external housing of the battery module 10, and may be configured as either an integrated or assembled structure with the bottom portion 170, which will be described herein.

The outer partition 120 may be configured to allow the first movable component 130 and the second movable component 150, which will be described herein, to pass therethrough, and may provide a guide for movement of the first movable component 130 and the second movable component 150.

The outer partition 120 may move the movable end block 110 along with the first movable component 130, and may move the movable partition 160, which will be described herein, along with the second movable component 150.

The first movable component 130 may be coupled to the movable end block 110 to move the movable end block 110. The movable end block 110 may support the outer partition 120, and may be moved by the first movable component 130, thus applying pressure to the cell stack 100.

In embodiments, as shown in (a) of FIG. 3, the first movable component 130 may be configured as a screw having a thread formed on a surface thereof, enabling the screw to move the movable end block 120 in one direction according to rotation thereof.

However, the screw illustrated in (a) of FIG. 3 may be merely an embodiment of the first movable component 130. The first movable component 130 may be configured in various structures, such as a hydraulic device or a pneumatic device. In other words, the first movable component 130 may be implemented in any configuration as long as it can achieve the purpose of moving the movable end block 120 in one direction.

Although in (a) of FIG. 3, one first movable component 130 is provided per movable end block 120, with a total of two illustrated, the number of first movable components 130 is not limited thereto and may be configured in a quantity that allows the movable end block 120 to be efficiently moved.

The inner partition 140 may be fixed to the outer partition 120, and may be positioned on opposite side surfaces of the cell stack 100, thus supporting the opposite side surfaces of the cell stack 100. In other words, the inner partition 140 may be configured to function as a side plate of the cell stack 100.

The inner partition 140 may guide the movement of the movable end block 10. The inner partition 140 may be configured to secure the movable end block 110 that has been moved by the first movable component 130.

In embodiments, the inner partition 140 may have a shape formed by bending a flat plate multiple times, and may support not only side surfaces of the cell stack 100 but also a bottom surface of the cell stack 100. For example, although not illustrated in the drawing, the inner partition 140 may be formed by bending a flat plate in a “U” shape to support the side surfaces and the bottom surface of the cell stack 100. The “U”-shaped inner partition 140 may be merely one embodiment, and the inner partition 140 may be applied in any shape as long as it is structured to support the side and bottom surfaces of the cell stack 100.

The second movable component 150 may be coupled to the movable partition 160, which will be described herein, and may be configured to move the movable partition 160.

In embodiments, as shown in (a) of FIG. 3, the second movable component 150 may be configured as a screw having a thread formed on a surface thereof, enabling the screw to move the movable partition 160 in one direction according to rotation thereof.

However, the screw illustrated in (a) of FIG. 3 may be merely an embodiment of the second movable component 150. The second movable component 150 may be configured in various structures, such as a hydraulic device or a pneumatic device. In other words, the second movable component 150 may be implemented in any configuration as long as it can achieve the purpose of moving the movable partition 160 in one direction.

Although in (a) of FIG. 3, two second movable components 150 are provided per movable partition 160, with a total of four illustrated, the number of second movable components 150 is not limited thereto and the second movable components 150 may be configured in a quantity that allows the movable partition 160 to be efficiently moved.

The movable partition 160 is an intermediate partition positioned between the outer partition 120 and the inner partition 140. The movable partition 160 may be configured to have the same height as the outer partition 120. As the movable partition 160 is configured to have the same height as the outer partition 120, an internal space may be formed between the outer partition 120 and the movable partition 160.

The movable partition 160 may move in one direction along the outer partition 120, and may serve to adjust the size of the internal space of the battery module 10. Due to the movement of the movable partition 160 in one direction, an internal space that is not used for test evaluation may be formed. Appropriate internal spaces of the battery module 10 may enhance the efficiency and accuracy of the test evaluation.

The movable partition 160 may be configured to be moved by the second movable component 150. In the case where the second movable component 150 is a screw, the movable partition 160 may move in engagement with the screw. However, in embodiments, the movable partition 160 may not be moved by the second movable component 150 but may further include various configurations capable of moving the movable partition 160.

The bottom portion 170 may be configured to form a bottom surface of the battery module 10, and may constitute the external housing of the battery module 10 along with the outer partition 120.

The bottom portion 170 may be coupled to the outer partition 120 and the inner partition 140, and may be configured to support the movable partition 160.

In embodiments, the bottom portion 170 may be configured as an integrated structure with the outer partition 120, or may be provided as a configuration separate from the outer partition 120 and connected to the outer partition 120 through fastening. The bottom portion 170 may be implemented in various forms capable of constituting the external housing of the battery module 10 along with the outer partition 120.

The cover portion 180, serving as a cover of the battery module 10, may be fastened to the outer partition 120 and configured to support the movable partition 160.

The pressure sensor 190 may be attached between the movable end block 110 and the first movable component 130, and may measure the pressure applied to the cell stack 100. The pressure sensor 190 may function to measure a value of compression force generated when the first movable component 130 presses the movable end block 110.

In embodiments, the pressure sensor 190 may include a load cell.

In embodiments, the pressure sensor 190 may be removed by retracting the first movable component 130. Since the pressure sensor 190 is not an essential component after the battery module 10 has been manufactured, the pressure sensor 190 may be removed after being used for pressure measurement.

In embodiments, the battery module 10 may further include at least one side partition (not illustrated). The side partition may be a partition that is fixed to the outer partition 120 and intersects the movable partition 160. The side partition may be configured to have the same height as the outer partition 120 and the movable partition 160, and may separate an internal space defined between the outer partition 120 and the movable partition 160.

The side partition may separate the internal space into a space required for test evaluation and an unnecessary space. In embodiments, the battery module 10 may be configured by filling the space required for test evaluation with various materials that can enhance the accuracy and efficiency of the test evaluation.

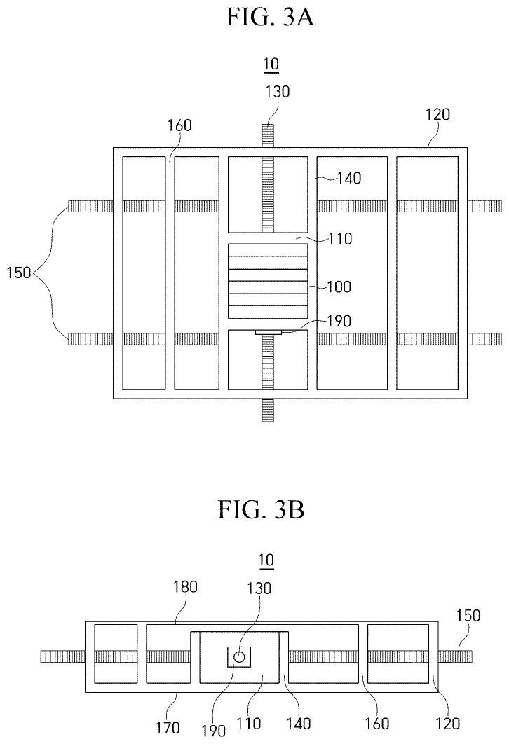

FIG. 4 is a front view (a) and a side view (b) illustrating a battery module 10 according to embodiments of the present disclosure.

Referring to FIGS. 4A and 4B, the battery module 10 according to the second embodiment of the present disclosure may be configured as a separate module in which the cell stack 100 is supported only by the bottom portion 170 without being supported by the outer partition 120.

The battery module 10 according to the second embodiment of the present disclosure may further include a first stationary end block 200, a second secondary end block 210, a side plate 220, a support component 230, and a fastening component 240.

The first stationary end block 200 may support one of outermost battery cells of the cell stack 100. The first stationary end block 200 may be secured to the side plate 220, which will be described herein, by the fastening component 240, which will be described herein.

The second stationary end block 210 may be coupled to one movable end block 110. The second stationary end block 210 may be coupled to the one movable end block 110 through the first movable component 130 and the support component 230, which will be described herein, and may be configured to provide a movement guide for the first movable component 130. The second stationary end block 210 may be secured to the side plate 220 by the fastening component 240.

The side plate 220 may secure the first stationary end block 200 and the second stationary end block 210, and may be configured to support side surfaces of the cell stack 100. The side plate 220 may secure the first stationary end block 200 and the second stationary end block 210 through the fastening component 240.

In embodiments, the side plate 220 may have a shape formed by bending a flat plate multiple times, and may support not only the side surfaces of the cell stack 100 but also the bottom surface of the cell stack 100. For example, although not illustrated in the drawing, the side plate 220 may be formed by bending a flat plate in a “U” shape to support the side surfaces and the bottom surface of the cell stack 100. The “U”-shaped side plate 220 may be one embodiment, and the side plate 220 may be applied in any shape as long as it is structured to support the side and bottom surfaces of the cell stack 100.

At least one support component 230 may support at least one point of the movable end block 110, with the first movable component 130 having moved the movable end block 110 and applied pressure to the cell stack 100.

In embodiments, as illustrated in (b) of FIG. 4, the support component 230 may include four support components, which support four points around a portion where the movable end block 110 is coupled to the first movable component 130. Furthermore, the support component 230 may be a screw having a thread formed on a surface thereof, enabling the screw to move according to rotation thereof and support the movable end block 110. The configuration of the support component 230 configured as a screw, as shown in (b) of FIG. 4, may be according to embodiments, and any configuration may be applied thereto as long as it can achieve the purpose of supporting the movable end block 110.

The at least one support component 230 may move until just before a measured value of the pressure sensor 170 varies, with the first movable component 130 having moved the movable end block 110 and applied pressure to the cell stack 100, and may support the movable end block 110. The fact that the measured value of the pressure sensor 170 varies when the at least one support component 230 is gradually moved, with the first movable component 130 having moved the movable end block 110 and applied pressure to the cell stack 100, may indicate that the at least one support component 230 influences the pressure applied to the movable end block 110 by the first movable component 130. Therefore, to prevent the aforementioned influence, the at least one support component 230 may move only to a position just before the measured value of the pressure sensor 170 varies, and support the movable end block 110.

At least one fastening component 240 may secure the first stationary end block 200 to the side plate 220, and may secure the second stationary end block 210 to the side plate 220. In embodiments, the fastening component 240 may be a component such as a bolt capable of securing at least two structures to each other.

In the battery module 10 according to the second embodiment of the present disclosure, similar to the battery module 10 according to the first embodiment described herein, an internal space may be formed between the outer partition 120 and the movable partition 160. The internal space may function as a sandbox for test evaluation. The movable partition 160 may be moved by the second movable component 150. As the movable partition 160 moves, the volume of the internal space may vary.

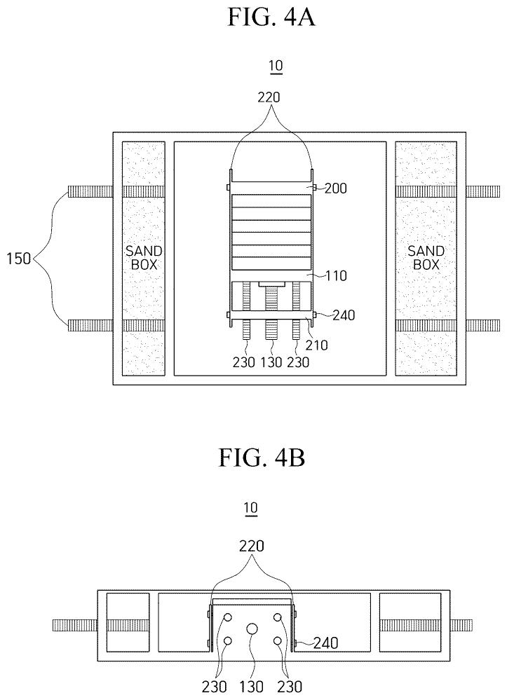

FIG. 5 is a side view illustrating a battery module 10 according to embodiments of the present disclosure.

Referring to FIG. 5, the battery module 10 according to the third embodiment may further include a sand block 300 and a third movable component (not illustrated).

The sand block 300 may be a separate block configured to perform the aforementioned sandbox function of the internal space. In embodiments, the sand block 300 may be configured as a hollow block or a block filled with various materials that include a heat conduction function required for test evaluation.

The third movable component may be configured to move the sand block 300 along with the aforementioned second movable component 150. The second movable component 150 may be configured to move the sand block 300 in one direction. The third movable component may be configured to move the sand block 300 in another direction. In embodiments, the second movable component 150 may be configured to move the sand block 300 in a left-right direction. The third movable component may be configured to move the sand block 300 in an up-down direction.

The third movable component may be configured to adjust the size of the sand block 300 along with the aforementioned second movable component 150. The second movable component 150 may be configured to adjust the size of the sand block 300 in one direction. The third movable component may be configured to adjust the size of the sand block 300 in another direction. In embodiments, the second movable component 150 may be configured to adjust the vertical size of the sand block 300. The third movable component may be configured to adjust the horizontal size of the sand block 300.

The battery module 10 according to the third embodiment may achieve the intended purpose thereof by replacing the internal space formed by the outer partition 120 and the movable partition 160 with the sand block 300, without using the aforementioned movable partition 160.

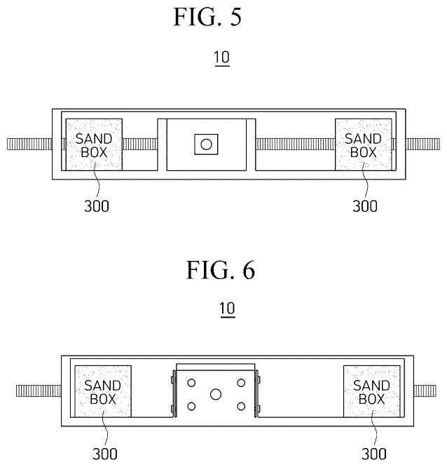

FIG. 6 is a side view illustrating a battery module 10 according to embodiments of the present disclosure.

Referring to FIG. 6, the battery module 10 according to the fourth embodiment may be configured by replacing the internal space formed by the outer partition 120 and the movable partition 160 with the sand block 300, without using the aforementioned movable partition 160, in the battery module 10 according to the second embodiment described herein.

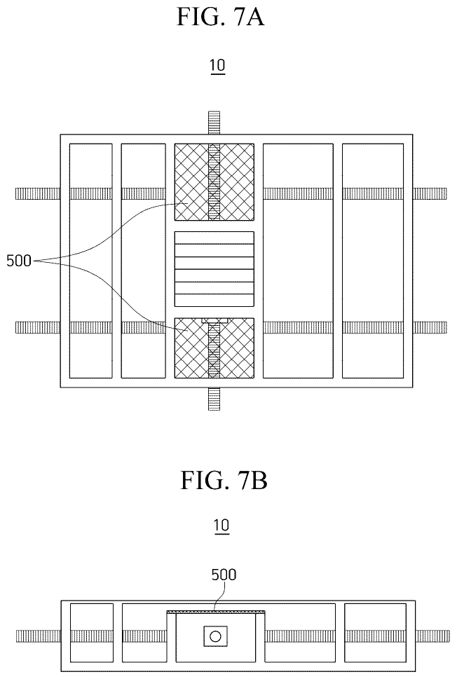

FIG. 7 is a front view (a) and a side view (b) illustrating a battery module 10 according to embodiments of the present disclosure.

Referring to FIGS. 7A and 7B, the battery module 10 according to embodiments may further include an upper sheet 500.

The upper sheet 500 may be a component positioned above an internal space formed by the movable end block 110, the outer partition 120, and the inner partition 140. The upper sheet 500 according to embodiments may be configured with a mica sheet having a constant thickness. The upper sheet 500 may perform a dummy cell function to enable the battery module 10 to be implemented in the size of an actual battery module. The upper sheet 500 according to embodiments may be configured with a sheet made of various materials capable of performing the dummy cell function, in addition to a mica sheet.

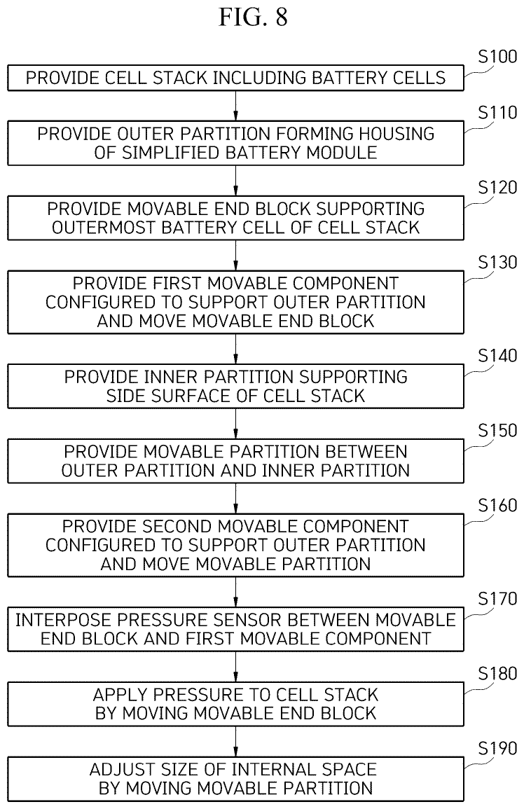

FIG. 8 is a flowchart for describing a method of manufacturing a battery module according to embodiments of the present disclosure.

Referring to FIG. 8, the method of manufacturing the battery module according to embodiments of the present disclosure may include steps S100 to S190.

Step S100 may include providing a cell stack including a plurality of battery cells.

Step S110 may include providing an outer partition that forms an external housing of the battery module.

Step S120 may include providing a movable end block that supports an outermost battery cell of the cell stack.

Step S130 may include providing first movable component that supports the outer partition and moves the movable end block.

Step S140 may include providing an inner partition that supports a side surface of the cell stack.

Step S150 may include providing a movable partition between the outer partition and the inner partition.

Step S160 may include providing a second movable component that supports the outer partition and moves the movable partition.

Step S170 may include interposing a pressure sensor between the movable end block and the first movable component.

Step S180 may include applying pressure to the cell stack by moving the movable end block.

Step S190 may include adjusting the size of an internal space by moving the movable partition.

The method of manufacturing the battery module according to embodiments of the present disclosure may further include removing the pressure sensor by retracting the first movable component.

The herein-mentioned method of manufacturing the battery module according to embodiments of the present disclosure has been described with reference to the flowchart shown in the drawing. For brief explanation, the method has been illustrated and described as a series of blocks, but the present disclosure is not limited to the order of the blocks. In other words, some blocks may be executed simultaneously with other blocks or in a different order from those illustrated and described in this specification, and various diverges, flow paths, block sequences may also be implemented if they give the equivalent or similar results. In addition, to implement the method described in the specification, it is also possible not to demand all blocks.

In the description with reference to FIG. 8, each step may be further divided into additional steps, or some steps may be combined as fewer steps, based on implementation embodiments of the present disclosure. Furthermore, some steps may be omitted as needed, and a sequence of steps may be changed. In addition, despite other omitted description, the description given with reference to FIGS. 1A to 7 may be applied to the description given with reference to FIG. 8. Moreover, the description provided with reference to FIG. 8 may be applied to the description provided with reference to FIGS. 1A to 7.

The steps illustrated in FIG. 8 may be implemented according to the first embodiment of the present disclosure and may further include steps implemented according to embodiments.

Hereinafter, materials which may be used in a secondary battery according to an embodiment of the present disclosure are described.

A compound (e.g., a lithiated intercalation compound) capable of reversible intercalation and deintercalation of lithium may be used as a positive electrode active material. Specifically, one type or more selected among complex oxides of metal, selected among cobalt, manganese, nickel, and a combination of them, and lithium may be used as the positive electrode active material.

The complex oxide may be lithium transition metal complex oxide. A detailed example of the complex oxide may include lithium nickel-based oxide, lithium cobalt-based oxide, lithium manganese-based oxide, a lithium ferrous phosphate-based compound, cobalt-free nickel-manganese-based oxide, or a combination of them.

For example, a compound that is represented as one of the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}CO_{c}L¹_{d}GₑO₂ (0.90≤a≤1.8, 0≤b≤0.9, 0≤c≤50.5, 0≤d≤0.5, 0≤e≤0.1); LiₐNiG_{b}O₂(0.90≤a≤1.8, 0.001≤b≤0.1); LiₐCoG_{b}O₂(0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the chemical formula, A may be Ni, Co, Mn, or a combination of them. X may be Al, Ni, Co, Mn, Cr, Fe, Mg, Sr, V, a rare earth element, or a combination of them; D may be O, F, S, P, or a combination of them. G may be Al, Cr, Mn, Fe, Mg, La, Ce, Sr, V, or a combination of them. L¹ may be Mn, Al, or a combination of them.

A positive electrode for a lithium secondary battery may include a current collector and a positive electrode active material layer formed on the current collector. The positive electrode active material layer may include the positive electrode active material, and may further include a binder and/or a conductive material.

Content of the positive electrode active material may be 90 wt. % to 99.5 wt. % with respect to the positive electrode active material layer 100 wt. %. Content of the binder and the conductive material may be 0. 5 wt. % to 5 wt. % with respect to the positive electrode active material layer 100 wt. %.

Al may be used as the current collector, but the present disclosure may not be limited thereto.

A negative electrode active material may include a material capable of reversibly Intercalation/de-Attorney intercalation with respect to lithium ions, lithium metal, an alloy of lithium metal, a material capable of doping and dedoping with respect to lithium, or transition metal oxide.

The material capable of reversibly Intercalation/de-intercalation with respect to lithium ions may include a carbon-based negative electrode active material, for example, crystalline carbon, amorphous carbon, or a combination of them. An example of the crystalline carbon may include graphite, such as natural graphite or synthetic graphite. Examples of the amorphous carbon may include soft or hard carbon, mesophase pitch carbide, and fired coke.

An Si-based negative electrode active material or an Sn-based negative electrode active material may be used as the material capable of doping and dedoping with respect to lithium. The Si-based negative electrode active material may be silicon, a silicon-carbon composite, SiOₓ (0<x<2), a Si-based alloy, or a combination of them.

The silicon-carbon composite may be a composite of silicon and amorphous carbon. According to an implementation example, the silicon-carbon composite may include silicon particles, and may have a form in which amorphous carbon has been coated on surfaces of silicon particles.

The silicon-carbon composite may further include crystalline carbon. For example, the silicon-carbon composite may include a core including crystalline carbon and silicon particles, and an amorphous carbon coating layer disposed on a surface of the core.

A negative electrode for a lithium secondary battery may include a current collector and a negative electrode active material layer disposed on the current collector. The negative electrode active material layer may include the negative electrode active material, and may further include a binder and/or a conductive material.

For example the negative electrode active material layer may include the negative electrode active material of 90 wt. % to 99 wt. %, the binder of 0.5 wt. % to 5 wt. %, and the conductive material of 0 wt. % to 5 wt. %.

A nonaqueous-based binder, an aqueous-based binder, a dry binder, or a combination of them may be used as the binder. If the aqueous-based binder is used as a binder for the negative electrode, the binder for the negative electrode may further include a cellulose-series compound capable of assigning viscosity.

One selected among nickel foil, stainless steel foil, titanium foil, nickel foam, copper foam, a polymer base on which a conductive metal has been coated, and a combination of them may be used as a current collector for the negative electrode.

An electrolyte for a lithium secondary battery may include a nonaqueous organic solvent and lithium salts.

The nonaqueous organic solvent may play a role as a medium through which ions that are involved in an electrochemical reaction of a battery can move.

The nonaqueous organic solvent may be a carbonate-based, ester-based, ether-based, ketone-based, or alcohol-based solvent, an aprotic solvent, or a combination of them. The carbonate-based, ester-based, ether-based, ketone-based, or alcohol-based solvent, or the aprotic solvent may be used solely, or two types or more of them may be mixed and used as the nonaqueous organic solvent.

Furthermore, if the carbonate-based solvent is used, annular carbonate and chain carbonate may be mixed and used.

A separator may be present between the positive electrode and the negative electrode depending on the type of lithium secondary battery. Polyethylene, polypropylene, and polyvinylidene fluoride, or a multi-layer having two or more layers of them may be used as the separator.

The separator may include a porous base, and a coating layer including an organic matter, an inorganic matter, or a combination of them that is disposed on one or both sides of the porous base.

The organic matter may include a polyvinylidene fluoride-based heavy antibody or (meth) acrylic polymer.

The inorganic matter may include inorganic particles selected among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination of them, but the present disclosure is not limited thereto.

The organic matter and the inorganic matter may have a form in which the organic matter and the inorganic matter have been mixed in one coating layer or a form in which a coating layer including the organic matter and a coating layer including the inorganic matter have been stacked.

Although the present disclosure has been described herein in connection with the limited embodiments and drawings, the present disclosure is not limited to the embodiments. A person having ordinary knowledge in the art to which the present disclosure pertains may modify and change the present disclosure within the technical spirit of the present disclosure and the equivalent range of the following claims.

What is claimed is:

1. A battery module comprising:
a cell stack comprising a plurality of battery cells;
an outer partition forming an external housing;
an inner partition fixed to the outer partition and supporting a side surface of the cell stack;
a movable end block supporting an outermost battery cell of the cell stack, and configured to move along the inner partition and apply pressure to the cell stack; and
a movable partition functioning as an intermediate partition positioned between the outer partition and the inner partition, the movable partition being configured to have a same height as the outer partition and define a first internal space between the outer partition and the movable partition,
wherein the movable partition moves along the outer partition and varies a size of the first internal space.

2. The battery module as claimed in claim 1, further comprising a first movable component coupled to a surface of the outer partition, and configured to move the movable end block.

3. The battery module as claimed in claim 2, further comprising a second movable component coupled to another surface of the outer partition, and configured to move the movable partition.

4. The battery module as claimed in claim 3, further comprising a pressure sensor interposed between the movable end block and the first movable component.

5. The battery module as claimed in claim 4, wherein the second movable component comprises a screw having a thread formed on a surface thereof so that the screw moves the movable partition according to rotation thereof.

6. The battery module as claimed in claim 1, further comprising an upper sheet positioned above a second internal space defined by the outer partition, the movable end block, and the inner partition, and configured to perform a dummy cell function.

7. The battery module as claimed in claim 6, wherein the upper sheet is formed of a mica sheet having a constant thickness.

8. A battery module comprising:
a cell stack comprising a plurality of battery cells;
an outer partition forming an external housing;
an inner partition fixed to the outer partition and supporting a side surface of the cell stack;
a movable end block supporting an outermost battery cell of the cell stack, and configured to move along the inner partition and apply pressure to the cell stack;
a sand block positioned between the outer partition and the inner partition, and configured to perform a sandbox function; and
a second movable component coupled to a surface of the outer partition, and configured to move the sand block in a direction.

9. The battery module as claimed in claim 8, further comprising a third movable component coupled to another surface of the outer partition, and configured to move the sand block in another direction.

10. The battery module as claimed in claim 9, wherein the second movable component and the third movable component are configured to adjust a size of the sand block.

11. A method of manufacturing a battery module, comprising:
providing a cell stack including a plurality of battery cells;
providing an outer partition forming an external housing;
providing an inner partition that is fixed to the outer partition and supports a side surface of the cell stack;
providing a movable end block that supports an outermost battery cell of the cell stack, moves along the inner partition, and applies pressure to the cell stack;
providing a movable partition functioning as an intermediate partition positioned between the outer partition and the inner partition, the movable partition being configured to have a same height as the outer partition and define a first internal space between the outer partition and the movable partition; and
moving the movable partition along the outer partition, and varying a size of the first internal space.

12. The method as claimed in claim 11, further comprising coupling a first movable component to a surface of the outer partition, the first movable component being configured to move the movable end block.

13. The method as claimed in claim 12, further comprising coupling a second movable component to another surface of the outer partition, the second movable component being configured to move the movable partition.

14. The method as claimed in claim 13, further comprising interposing a pressure sensor between the movable end block and the first movable component.

15. The method as claimed in claim 14, wherein the second movable component comprises a screw having a thread formed on a surface thereof so that the screw moves the movable partition according to rotation thereof.

16. The method as claimed in claim 11, further comprising providing an upper sheet above a second internal space defined by the outer partition, the movable end block, and the inner partition, the upper sheet performing a dummy cell function.

17. The method as claimed in claim 16, wherein the upper sheet is formed of a mica sheet having a constant thickness.

18. A method of manufacturing a battery module, comprising:
providing a cell stack including a plurality of battery cells;
providing an outer partition forming an external housing;
providing an inner partition that is fixed to the outer partition and supports a side surface of the cell stack;
providing a movable end block that supports an outermost battery cell of the cell stack, moves along the inner partition, and applies pressure to the cell stack;
providing a sand block positioned between the outer partition and the inner partition and configured to perform a sandbox function; and
coupling a second movable component to a surface of the outer partition, the second movable component being configured to move the sand block in a direction.

19. The method as claimed in claim 18, further comprising coupling a third movable component to another surface of the outer partition, the third movable component being configured to move the sand block in another direction.

20. The method as claimed in claim 19, further comprising adjusting a size of the sand block by using the second movable component and the third movable component.
